(19) United States
(12) Patent Application Publication
(10) Pub. No.: US 2014/0338969 A1
(43) Pub. Date: Nov. 20, 2014

(54) OPTICAL-ELECTRICAL COMPOSITE CABLE

(71) Applicant: SUMITOMO ELECTRIC INDUSTRIES, LTD., Osaka-shi, Osaka (JP)

(72) Inventors: Itaru Sakabe, Yokohama-shi (JP); Yuya Homma, Yokohama-shi (JP); Tatsunori Hayashishita, Hachinohe-shi (JP)

(21) Appl. No.: 14/364,813

(22) PCT Filed: Oct. 10, 2013
(86) PCT No.: PCT/JP2013/077651

§ 371 Date: Jun. 12, 2014

(30) Foreign Application Priority Data
Oct. 11, 2012 (JP) 2012-226086

(51) Int. Cl. H01B 11/22

(52) U.S. Cl. CPC H01B 11/22
USPC 174/70 R

(57) ABSTRACT

An optical-electrical composite cable 1A includes a ribbon optical fiber 10 including a plurality of optical fibers, a tube 20 accommodating the ribbon optical fiber 10, a sheath 50 covering the tube 20, and a plurality of electric wires 60 arranged between an outer surface of the tube 20 and an inner surface of the sheath 50. A center axis line of the tube 20 and a center axis line of the sheath 50 are apart from each other. The center axis line of the sheath 50 is located inside the tube 20. The plurality of electric wires 60 is located eccentrically on an opposite side to the center axis line of the tube 20 with respect to the center axis line of the sheath 50. Such a configuration provides an optical-electrical composite cable that has an even smaller diameter.

### TECHNICAL FIELD

The present invention relates to an optical-electrical composite cable.

### BACKGROUND ART

Patent Literature 1 describes a technique related to an optical-electrical composite cable. This optical-electrical composite cable includes an optical fiber and a plurality of electric wires inside a sheath. The plurality of electric wires is arranged around the optical fiber, and the optical fiber is accommodated inside a tube. The plurality of electric wires includes a single electric wire and a pair of electric wires, which are arranged diagonally to each other. A filler is provided in a gap between the single electric wire and the pair of electric wires on the outside of the tube.

### CITATION LIST

### Patent Literature

Patent Literature 1: Japanese Patent Application Laid-Open Publication No. 2012-043557

### SUMMARY OF INVENTION

### Technical Problem

Recently, data transmission capacity between electronic devices, such as personal computers and peripheral devices have increased, and even faster communication speed has been required. A system is therefore often employed in which information transmission between electronic devices is performed using optical fibers and power supply from one electronic device to the other electronic device is performed using electric wires. In this case, optical-electrical composite cables are suitably used which are formed by combining electric wires and optical fibers with each other.

For example, the optical-electrical composite cable described in Patent Literature 1 above can achieve good mechanical characteristics because a plurality of electric wires are arranged diagonally to each other. However, a further decrease in the diameter of the optical-electrical composite cable has been required, for example, due to reduction in the size of connectors provided at both ends of the optical-electrical composite cable.

The present invention aims to provide an optical-electrical composite cable that has an even smaller diameter.

### Solution to Problem

An optical-electrical composite cable according to an embodiment of the present invention includes one or more optical fibers, a tube accommodating the one or more optical fibers, a sheath covering the tube, and a plurality of electric wires arranged between an outer surface of the tube and an inner surface of the sheath. A center axis line of the tube and a center axis line of the sheath are apart from each other. The center axis line of the sheath is located inside the tube. The plurality of electric wires is located eccentrically on an opposite side to the center axis line of the tube with respect to the center axis line of the sheath.

In this optical-electrical composite cable, the center axis line of the tube and the center axis line of the sheath are apart from each other, and the plurality of electric wires are located eccentrically on the opposite side to the center axis line of the tube with respect to the center axis line of the sheath. Accordingly, when compared with a configuration in which electric wires are arranged diagonally with the center axis line of the sheath interposed therebetween, for example, as described in Patent Literature 1, or a plurality of electric wires are arranged equally around the center axis line of the sheath (that is, a configuration in which the center axis line of the tube is generally coincident with the center axis line of the sheath), the outer diameter of the optical-electrical composite cable can be further reduced by at least the outer diameter of one electric wire.

In this optical-electrical composite cable, since the center axis line of the sheath is located inside the tube, the one or more optical fibers in the tube can be located on the center axis line of the sheath or in the vicinity of the center axis line. Accordingly, when the optical-electrical composite cable is bent, the one or more optical fibers are displaced to the vicinity of the center axis line of the sheath (that is, the bending center of the cable) to reduce lateral pressure and tension stress. The optical-electrical composite cable described above can therefore achieve good optical transmission characteristics and time to failure.

In the optical-electrical composite cable, the following formula may be satisfied:

D1+2d1−D2≧\sqrt{(D1+D2)²−D2²} [Formula 1]

wherein D1 is an outer diameter of the tube, d1 is an inner diameter of the tube, and D2 is an outer diameter of a thickest electric wire of the plurality of electric wires. Accordingly, the structure in which the center axis line of the sheath is located inside the tube is suitably implemented.

The optical-electrical composite cable may further include one or more fillers arranged between the outer surface of the tube and the inner surface of the sheath. In this case, in the optical-electrical composite cable, the following formula may be satisfied:

D+2d1−D2≧\sqrt{(D1+D2)²−D2²}[Formula 2]

wherein D1 is an outer diameter of the tube, d1 is an inner diameter of the tube, and D2 is an outer diameter of a thickest electric wire or filler of the plurality of electric wires and the one or more fillers. Accordingly, the structure in which the center axis line of the sheath is located inside the tube is suitably implemented.

In the optical-electrical composite cable, the tube and all or at least some of the plurality of electric wires may be intertwisted together, and at least the tube may be intertwisted while being back-twisted. When the tube is intertwisted with the electric wires, without the back-twisting of the tube, the optical fibers in the tube make one turn for each twist pitch. Accordingly, a large torsion distortion occurs in the optical fiber, and the optical fiber in an attempt to release the torsion sticks to the inner surface of the tube and receives a large lateral pressure, possibly resulting in an increase in transmission loss. By contrast, the tube is intertwisted with at least some of the electric wires while being back-twisted as described above, whereby lateral pressure on the optical fiber can be reduced and transmission loss can be suppressed.

In the optical-electrical composite cable, the tube and all or at least some of the electric wires may be assembled while extending in parallel with each other along the center axis line of the sheath.

### Advantageous Effects of Invention

The optical-electrical composite cable according to the present invention has an even smaller diameter.

### BRIEF DESCRIPTION OF DRAWINGS

FIG. 1 is a cross-sectional view showing a structure of an optical-electrical composite cable according to a first embodiment.

FIG. 2 is a diagram showing a cross-sectional structure example of a ribbon optical fiber.

FIG. 3 is a diagram schematically showing a cross section of the optical-electrical composite cable according to the first embodiment.

FIG. 4 is a cross-sectional view showing a structure of an optical-electrical composite cable according to a second embodiment of the present invention.

FIG. 5 is a cross-sectional view showing a structure of an optical-electrical composite cable according to a third embodiment of the present invention.

FIG. 6 is a cross-sectional view showing a structure of an optical-electrical composite cable according to a fourth embodiment of the present invention.

FIG. 7 is a cross-sectional view showing a structure of an optical-electrical composite cable according to a fifth embodiment of the present invention.

FIG. 8 is a cross-sectional view showing a structure of an optical-electrical composite cable according to a sixth embodiment of the present invention.

### DESCRIPTION OF EMBODIMENTS

Embodiments of an optical-electrical composite cable according to the present invention will be described in details below with reference to the accompanying drawings. It should be noted that in the description of the drawings, the same components are denoted with the same reference signs and an overlapping description is omitted.

### First Embodiment

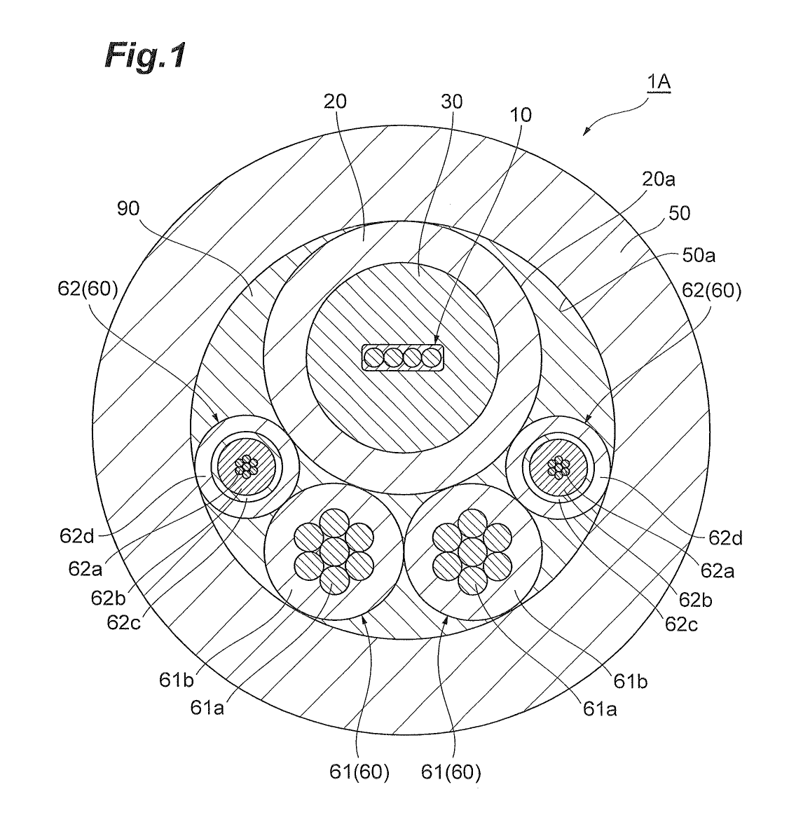

FIG. 1 is a cross-sectional view showing a structure of an optical-electrical composite cable 1A according to a first embodiment of the present invention. This view shows a cross section perpendicular to the center axis direction of the optical-electrical composite cable 1A. As shown in the view, the optical-electrical composite cable 1A in the present embodiment includes a ribbon optical fiber 10, a cylindrical tube 20 accommodating the ribbon optical fiber 10, a sheath 50 covering the tube 20, and a plurality of electric wires 60.

The ribbon optical fiber 10 is formed by integrating a plurality of (for example, even-numbered) optical fibers arranged in parallel. The ribbon optical fiber 10 is arranged in an interior space of the tube 20 and can move freely in the interior space. The tube 20 is formed of, for example, polyvinyl chloride. In the present embodiment, one ribbon optical fiber 10 is arranged in the interior space of the tube 20. The inner diameter (the diameter of the interior space) of the tube 20 is greater than the width of the ribbon optical fiber 10 (the width in the direction in which a plurality of optical fibers are arranged), for example, 1.4 mm. The outer diameter of the tube 20 is, for example, 2.0 mm.

A tension member 30 may be provided in a gap between the inner surface of the tube 20 and the ribbon optical fiber 10. The tension member 30 is preferably in the form of fiber and is formed of, for example, an aramid fiber such as Kevlar (registered trademark).

The sheath 50 is provided to protect the optical-electrical composite cable 1A as a whole. The sheath 50 is approximately shaped like a cylinder and is formed of, for example, polyvinyl chloride, polyethylene, or polyolefin such as Ethylene-Vinyl Acetate (EVA). The sheath 50 covers a plurality of electric wires 60 as well as the tube 20. The outer diameter of the sheath 50 is, for example, 4.5 mm. The thickness of the sheath 50 is, for example, 0.35 mm.

A plurality of electric wires 60 is arranged between the outer surface 20a of the tube 20 and the inner surface 50a of the sheath 50. Each electric wire 60 is in contact with both the outer surface 20a and the inner surface 50a, and adjacent electric wires 60 are in contact with each other. A plurality of electric wires 60 includes a power line 61 and a coaxial wire 62. In the present embodiment, two power lines 61 and two coaxial wires 62 are provided. The power line 61 includes a plurality of conductors 61a and an insulating coating material 61b covering these conductors 61a. The diameter of the power line 61 (that is, the outer diameter of the coating material 61b) is, for example, 1.0 mm. The power lines 61 are provided to transmit electric power from one to the other of electronic device connected with each other through the optical-electrical composite cable 1A.

The coaxial wire 62 includes a plurality of metal inner conductors 62a and an outer conductor 62c for shielding that surrounds the inner conductors 62a. The coaxial wire 62 also includes an insulating dielectric 62b arranged between the inner conductors 62a and the outer conductor 62c, and an insulating protective coating 62d accommodating the inner conductors 62a, the dielectric 62b, and the outer conductor 62c. The diameter of the coaxial wire 62 (that is, the outer diameter of the protective coating 62d) is, for example, 0.5 mm. The coaxial wires 62 are provided to transmit an electrical signal transmitted/received between electronic devices connected with each other through the optical-electrical composite cable 1A.

A fiber-like tension member 90 is arranged in the interior space of the sheath 50 excluding the electric wires 60 and the tube 20. The tension member 90 is formed of, for example, yarn of polypropylene and enhances tension force of the optical-electrical composite cable 1A to prevent breakage of the electric wires 60 and the like.

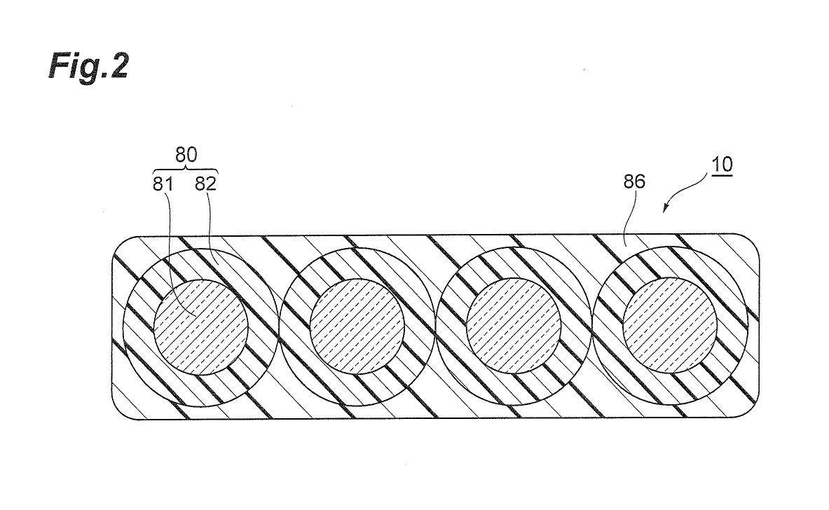

FIG. 2 is a diagram showing a cross-sectional structure example of the ribbon optical fiber 10. The ribbon optical fiber 10 shown in this diagram is formed by arranging four optical fibers 80 in parallel and integrating these fibers with a coating 86. Each optical fiber 80 includes a core 81 and a cladding 82 surrounding the core 81.

The core 81 has a refractive index higher than the refractive index of the cladding 82 and can propagate light. The core 81 may be formed of, for example, glass. The cladding 82 can be formed of glass or may be formed of plastic. An optical fiber in which both the core 81 and the cladding 82 are made of glass is called an all glass fiber (AGF), and an optical fiber in which the core 81 is made of glass and the cladding 82 is made of plastic is called a hard plastic cladding fiber (HPCF). Of these fibers, an HPCF tends to have a greater optical loss due to lateral pressure because the Young's modulus of the plastic forming the cladding is low. In order to improve the lateral pressure resistance, it is preferable that the ribbon optical fiber be formed with a plurality of HPCFs arranged in parallel. The optical-electrical composite cable 1A therefore includes the ribbon optical fiber 10 having a plurality of HPCFs arranged in parallel thereby to achieve a good lateral pressure resistance and an excellent breakage resistance.

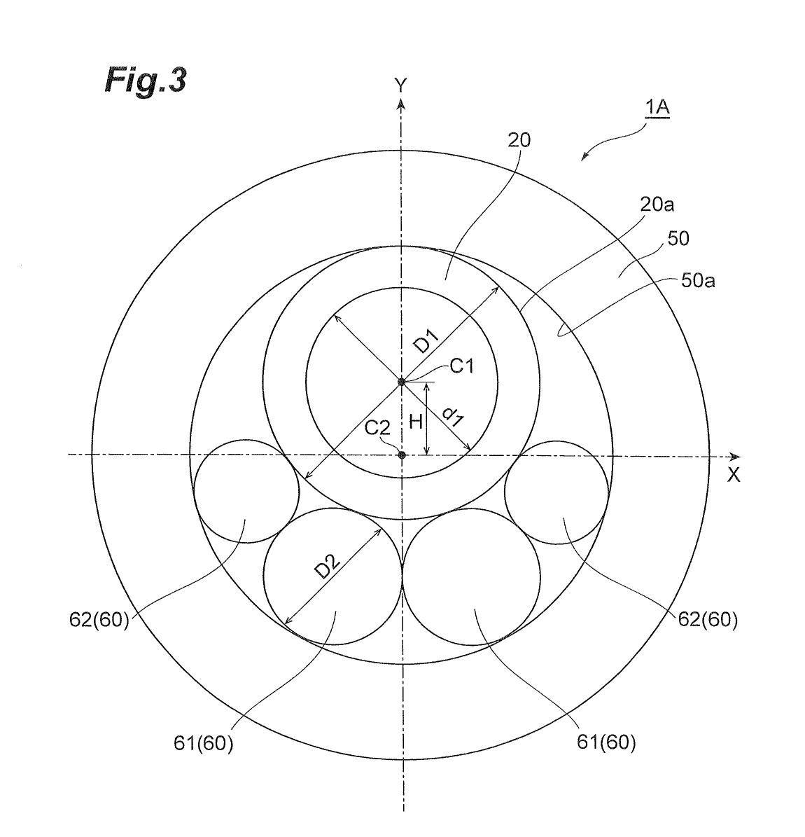

FIG. 3 is a diagram schematically showing a cross section of the optical-electrical composite cable 1A and shows a cross section perpendicular to the center axis line of the optical-electrical composite cable 1A. This diagram shows the outer diameter D1 and the inner diameter d1 of the tube 20, and the outer diameter D2 of the thickest one of the plurality of electric wires 60 (in the present embodiment, the power line 61). The diagram also shows the center axis line C1 of the tube 20 and the center axis line C2 of the sheath 50. For ease of understanding, the diagram shows the X axis and the Y axis. The X and Y axes are orthogonal to the center axis line of the optical-electrical composite cable 1A and are orthogonal to each other.

In the present embodiment, the center axis line C1 of the tube 20 and the center axis line C2 of the sheath 50 are apart from each other. In FIG. 3, the center axis line C2 of the sheath 50 is located at the intersection of the X axis and the Y axis, and the center axis line C1 of the tube 20 is located at a distance H from that intersection (the center axis line C2) in the positive direction of the Y axis.

Since the tube 20 is located eccentrically in the sheath 50 in this manner, the space on the positive side of the Y axis in the sheath 50 is narrow, and conversely, the space on the negative side of the Y axis is wide. A plurality of electric wires 60 are arranged in this wide space. That is, the plurality of electric wires 60 in the present embodiment are not arranged equally around the center axis line C2 of the sheath 50 but located eccentrically in the area opposite to the center axis line C1 of the tube 20 with respect to the center axis line C2. More specifically, the power lines 61 having a large diameter are arranged in the area where the distance between the outer surface 20a of the tube 20 and the inner surface 50a of the sheath 50 is the largest (that is, the area adjacent to the plane including the center axis lines C1 and C2 in the gap between the tube 20 and the sheath 50), and the coaxial wires 62 having small diameter are arranged on the periphery thereof. In the present embodiment, as shown in FIG. 3, the center axis line Cl of the tube 20 is present in the positive area of the Y axis whereas the center axis line of each of the power line 61 and the coaxial wire 62 is present in the negative area of the Y axis.

In the present embodiment, the center axis line C2 of the sheath 50 is located inside the tube 20. In other words, the tube 20 is arranged eccentrically in the positive direction of the Y axis in the space inside of the sheath 50, and the center axis line C2 of the sheath 50 is included in the space inside of the tube 20. Such a configuration is suitably implemented, for example, when the following Formula (1) is satisfied:

[Formula 3]

D1+2d1−D2≧\sqrt{(D1+D2)²−D2²} (1)

The advantageous effects achieved by the optical-electrical composite cable 1A having the structure as described above will be described. In the optical-electrical composite cable 1A, the center axis line C1 of the tube 20 and the center axis line C2 of the sheath 50 are apart from each other, and a plurality of electric wires 60 are located eccentrically on the opposite side to the center axis line C1 of the tube 20 with respect to the center axis line C2 of the sheath 50. Accordingly, when compared with a configuration in which electric wires are arranged diagonally with the center axis line of the sheath interposed therebetween, for example, as described in Patent Literature 1, or a plurality of electric wires are arranged equally around the center axis line of the sheath (that is, a configuration in which the center axis line of the tube is generally coincident with the center axis line of the sheath), the outer diameter of the optical-electrical composite cable 1A can be further reduced by at least the outer diameter of one electric wire 60.

In the optical-electrical composite cable 1A, since the center axis line C2 of the sheath 50 is located inside the tube 20, the ribbon optical fiber 10 in the tube 20 can be located on the center axis line C2 of the sheath 50 or in the vicinity of the center axis line C2. Accordingly, when the optical-electrical composite cable 1A is bent, the ribbon optical fiber 10 is displaced to the vicinity of the center axis line C2 of the sheath 50 (that is, the bending center of the cable 1A) to reduce lateral pressure and tensile stress. The optical-electrical composite cable 1A according to the present embodiment thus can achieve good optical transmission characteristics and time to failure.

Although, in the present embodiment, the ribbon optical fiber 10 is formed with a plurality of optical fibers 80 integrally arranged in parallel, the optical fibers in the tube 20 may not be integrated in this manner. The advantageous effects of the present embodiment as described above can be achieved even when there is a single optical fiber in the tube 20, rather than a plurality of optical fibers.

In the optical-electrical composite cable 1A in the present embodiment, the tube 20 and all or at least some of the plurality of electric wires 60 may be intertwisted together and assembled each other. In this case, it is preferable that at least the tube 20 be intertwisted while being back-twisted, for example, once for each twist pitch. When the tube 20 is intertwisted with the electric wires 60, without the back-twisting of the tube 20, the ribbon optical fiber 10 in the tube 20 makes one turn for each twist pitch. Accordingly, a large torsion distortion occurs in the ribbon optical fiber 10, and the ribbon optical fiber 10 contacts with the inner surface of the tube 20 to release the torsion and receives a large lateral pressure, possibly resulting in an increase in transmission loss. By contrast, the tube 20 is intertwisted with at least some of the electric wires 60 while being back-twisted as described above, whereby the lateral pressure on each optical fiber 80 in the ribbon optical fiber 10 can be reduced, and transmission loss can be suppressed. When the tube 20 is intertwisted with other electric wires 60 in this manner, the ribbon optical fiber 10 in the tube 20 slightly waves. This provides an excess length for the ribbon optical fiber 10 to absorb elongation and withstand elongation when the ribbon optical fiber 10 elongates in accordance with bending of the optical-electrical composite cable 1A.

Alternatively, in the optical-electrical composite cable 1A in the present embodiment, the tube 20 and all or at least some of the electric wires 60 may extend in parallel with each other along the center axis line C2 of the sheath 50 without being intertwisted with each other. In this case, it is preferable that the tube 20 and the electric wires 60 be wrapped with, for example, tape-like paper or polyethylene terephthalate (PET) and assembled with each other.

### Second Embodiment

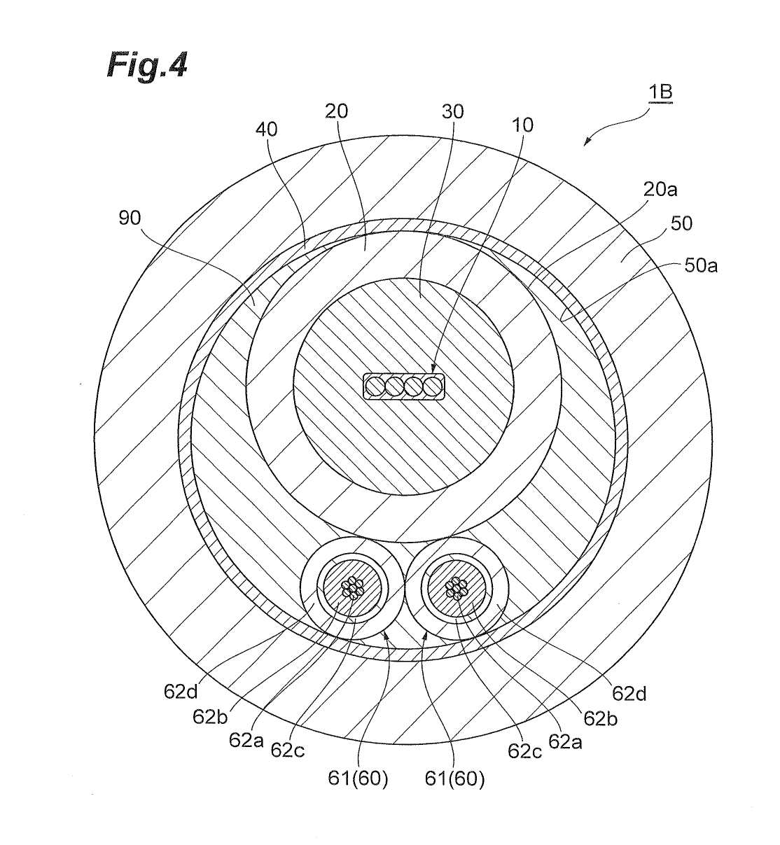

FIG. 4 is a cross-sectional view showing a structure of an optical-electrical composite cable 1B according to a second embodiment of the present invention. This view shows a cross section perpendicular to the center axis direction of the optical-electrical composite cable 1B. As shown in the view, the optical-electrical composite cable 1B in the present embodiment includes a ribbon optical fiber 10, a tube 20, a tension member 30, a sheath 50, a plurality of electric wires 60, and a tension member 90. The structure of those excluding a plurality of electric wires 60 is the same as in the first embodiment, and a detailed description therefore will be omitted.

In the present embodiment, a plurality of electric wires 60 do not include a power line 61 (see FIG. 1), and only two coaxial wires 62 are arranged as electric wires 60 in the sheath 50. The outer diameter of the sheath 50 is thereby thinner than in the first embodiment, for example, 4.2 mm.

In the present embodiment, the center axis line of the tube 20 and the center axis line of the sheath 50 are apart from each other in the same manner as in the first embodiment. The two coaxial wires 62 are located eccentrically in the area opposite to the center axis line of the tube 20 with respect to the center axis line of the sheath 50. More specifically, two coaxial wires 62 are arranged in the area where the distance between the outer surface 20a of the tube 20 and the inner surface 50a of the sheath 50 is the largest (that is, the area adjacent to the plane including these center axis lines in the gap between the tube 20 and the sheath 50).

In the present embodiment, the center axis line of the sheath 50 is located inside the tube 20. Such a configuration is suitably implemented, for example, when Formula (1) above is satisfied where the outer diameter of the tube 20 is D1, the inner diameter of the tube 20 is d1, and the outer diameter of the thickest electric wire 60 of the plurality of electric wires 60 (that is, the outer diameter of the coaxial wire 62) is D2.

The optical-electrical composite cable 1B in the present embodiment further includes an electromagnetic shield layer 40. The electromagnetic shield layer 40 is provided, for example, between the tension member 90 and the sheath 50. The electromagnetic shield layer 40 is suitably formed with, for example, a tape-like metal or a metal wire spiral or braid.

In the optical-electrical composite cable 1B in the present embodiment, the center axis line of the tube 20 and the center axis line of the sheath 50 are apart from each other, and the two coaxial wires 62 are located eccentrically on the opposite side to the center axis line of the tube 20 with respect to the center axis line of the sheath 50, so that the outer diameter of the optical-electrical composite cable 1B can be further reduced. Also in the optical-electrical composite cable 1B, since the center axis line of the sheath 50 is located inside the tube 20, the ribbon optical fiber 10 in the tube 20 can be located on the center axis line of the sheath 50 or in the vicinity of the center axis line. Accordingly, lateral pressure and tension stress can be reduced when the optical-electrical composite cable 1B is bent, and good optical transmission characteristics and time to failure can be achieved.

### Third Embodiment

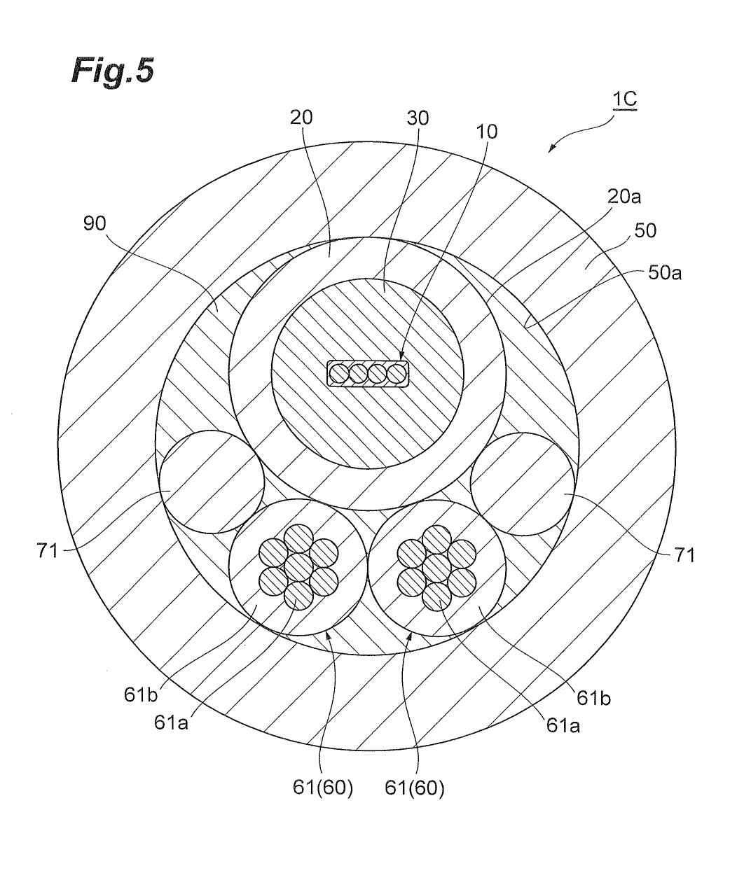

FIG. 5 is a cross-sectional view showing a structure of an optical-electrical composite cable 1C according to a third embodiment of the present invention. This view shows a cross section perpendicular to the center axis direction of the optical-electrical composite cable 1C. As shown in the view, the optical-electrical composite cable 1C in the present embodiment includes a ribbon optical fiber 10, a tube 20, a tension member 30, a sheath 50, a plurality of electric wires 60, fillers 70, and a tension member 90. The structures of those excluding the electric wires 60 and the fillers 71 are the same as in the first embodiment.

The optical-electrical composite cable 1C includes two fillers 71 in place of two coaxial wires 62 in the first embodiment. The fillers 71 each are a wire member circular in cross section that is formed of a material, for example, such as nylon, polypropylene, or staple fiber, and has, for example, the same outer diameter as the coaxial wire 62 in the first embodiment. The fillers 71 are provided to stabilize the relative position of the tube 20 and each electric wire 60.

As in the present embodiment, the fillers 71 may be arranged between the sheath 50 and the tube 20 in place of one or more electric wires 60 in the first embodiment or in addition to a plurality of electric wires 60. Such a configuration can also suitably achieve the advantageous effects of the foregoing first embodiment. That is, the electric wires 60 and the fillers 71 are located eccentrically on the opposite side to the center axis line of the tube 20 with respect to the center axis line of the sheath 50, so that the outer diameter of the optical-electrical composite cable 1C can be further reduced.

### Fourth Embodiment

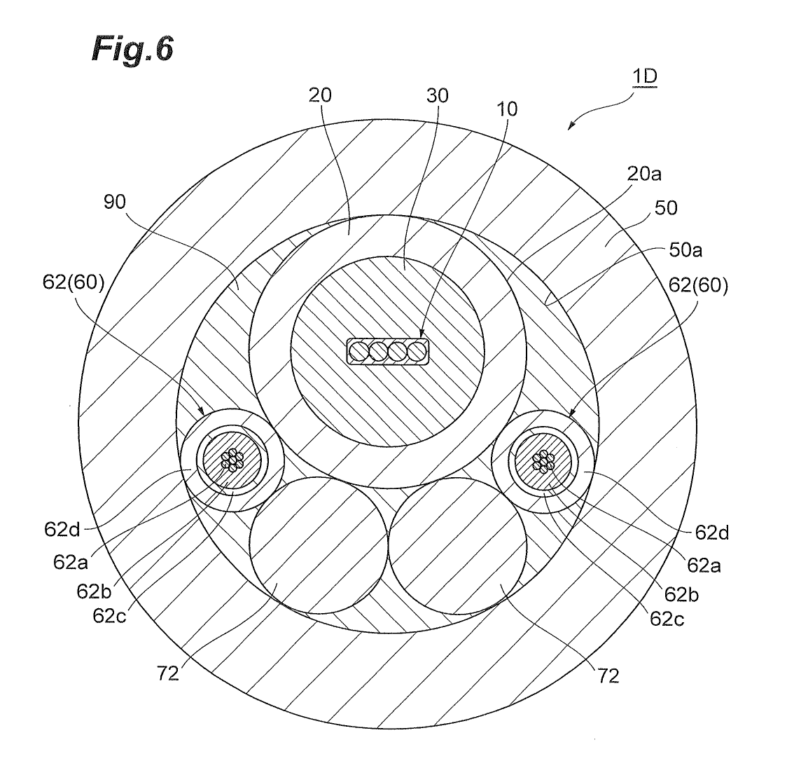

FIG. 6 is a cross-sectional view showing a structure of an optical-electrical composite cable 1D according to a fourth embodiment of the present invention. This view shows a cross section perpendicular to the center axis direction of the optical-electrical composite cable 1D. As shown in the view, the optical-electrical composite cable 1D in the present embodiment includes a ribbon optical fiber 10, a tube 20, a tension member 30, a sheath 50, a plurality of electric wires 60, fillers 72, and a tension member 90. The structure of those excluding the electric wires 60 and the fillers 72 are the same as in the first embodiment.

The optical-electrical composite cable 1D includes two fillers 72 in place of two power lines 61 in the first embodiment. The filler 72 each are a wire member circular in cross section, and the constituent material and the purpose of installation thereof are the same as those of the filler 71 in the third embodiment. In the present embodiment, however, the fillers 72 are provided in place of the power lines 61 thicker than the coaxial wires 62, so that the outer diameter of the filler 72 can have an impact on Formula (1) above which is the requirement for the center axis line C2 of the sheath 50 to be located inside the tube 20. That is, in the present embodiment, Formula (1) above can be satisfied when the outer diameter of the filler 72 is D2.

That is, in the foregoing third embodiment and in the present embodiment, Formula (1) above is satisfied when the outer diameter of the thickest electric wire 60 or filler 72 (71) of a plurality of electric wires 60 and one or more fillers 72 (71) is D2, whereby the center axis line of the sheath 50 can be suitably located inside the tube 20. Accordingly, when the optical-electrical composite cable 1D (1C) is bent, the ribbon optical fiber 10 is displaced to the vicinity of the center axis line of the sheath 50 (that is, the bending center of the cable) to reduce lateral pressure and tension stress, so that good optical transmission characteristics and time to failure can be achieved.

In the present embodiment, the electric wires 60 and the fillers 72 are located eccentrically on the opposite side to the center axis line of the tube 20 with respect to the center axis line of the sheath 50 in the same manner as in the third embodiment, so that the outer diameter of the optical-electrical composite cable 1D can be further reduced. In the third embodiment and the present embodiment, the number and the thickness of fillers 71 (72) are set as desired.

### Fifth Embodiment

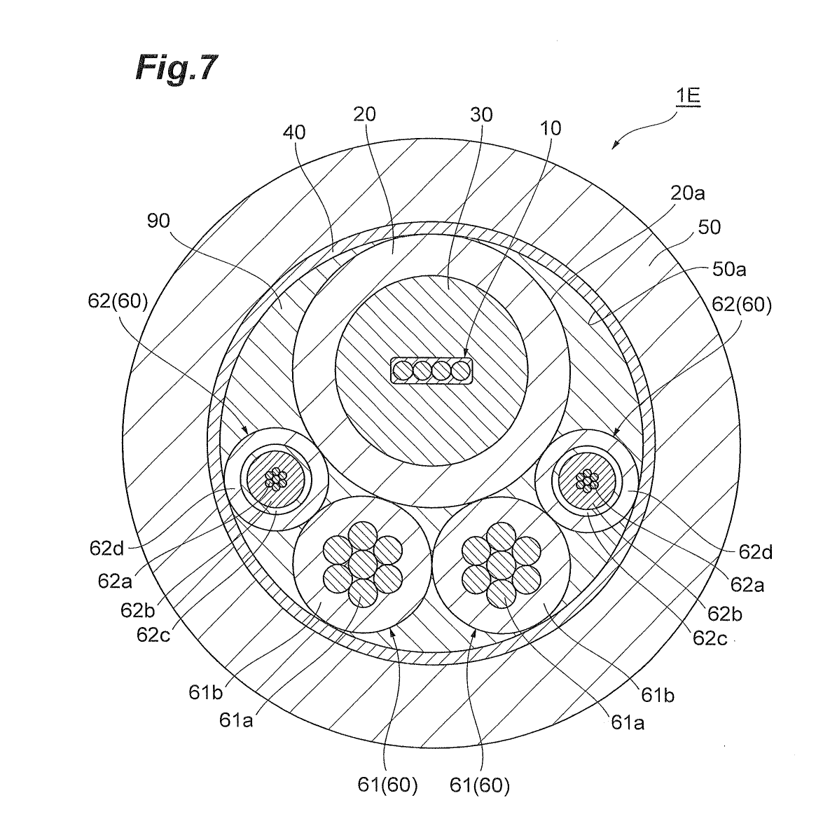

FIG. 7 is a cross-sectional view showing a structure of an optical-electrical composite cable 1E according to a fifth embodiment of the present invention. This view shows a cross section perpendicular to the center axis direction of the optical-electrical composite cable 1E. As shown in the view, the optical-electrical composite cable 1E in the present embodiment further includes an electromagnetic shield layer 40 in addition to the structure of the optical-electrical composite cable 1A in the first embodiment. The structure and operation of the electromagnetic shield layer 40 is the same as in the second embodiment.

### Sixth Embodiment

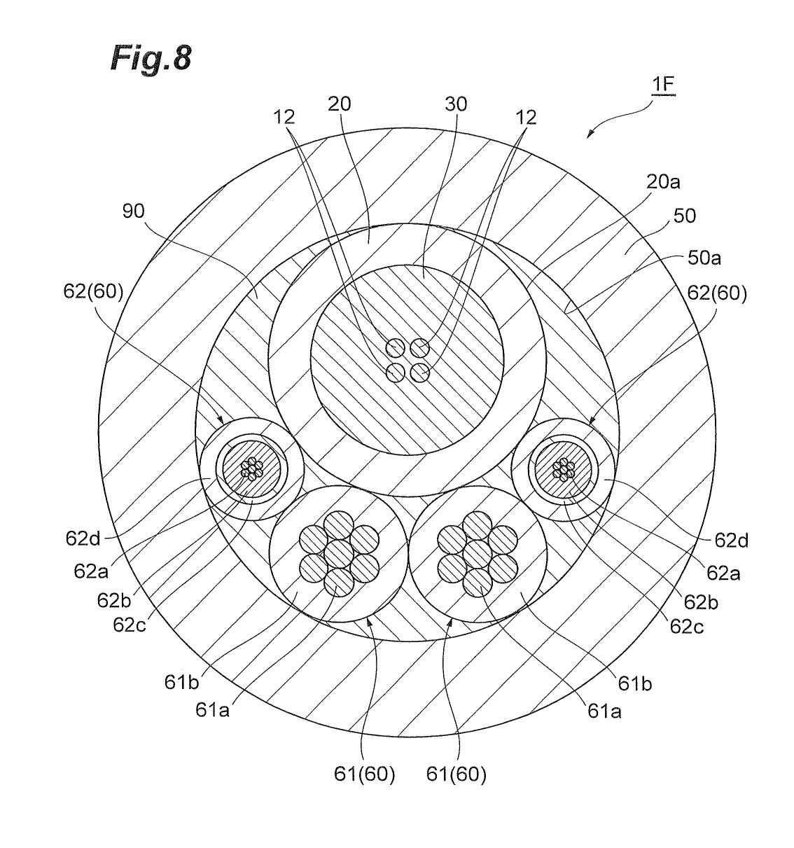

FIG. 8 is a cross-sectional view showing a structure of an optical-electrical composite cable 1F according to a sixth embodiment of the present invention. This view shows a cross section perpendicular to the center axis direction of the optical-electrical composite cable 1F. As shown in the view, the optical-electrical composite cable 1F in the present embodiment includes a plurality of optical fiber core wires 12 in place of the ribbon optical fiber 10 in the first embodiment. These optical fiber core wires 12 each include, for example, the optical fiber 80 (the core 81 and the cladding 82) shown in FIG. 2 and extend along the center axis direction of the optical-electrical composite cable 1F.

A plurality of optical fibers accommodated in the tube 20 may be arranged so as to be separated from each other as in the present embodiment, rather than being integrated as the ribbon optical fiber 10 as in the foregoing embodiments. Also in this case, the advantageous effects in the foregoing embodiments can be suitably achieved.

The optical-electrical composite cable according to the present invention is not limited to the foregoing embodiments and is susceptible to other various modifications. For example, although two or four electric wires 60 are provided in the foregoing embodiments, the number of electric wires 60 is not limited thereto. Although the ribbon optical fiber 10 in which a plurality of optical fibers 80 are integrated, or a plurality of optical fiber core wires 12 are accommodated in the tube 20 in the foregoing embodiments, a single optical fiber may be accommodated in the tube 20.

### INDUSTRIAL APPLICABILITY

The present invention can be used as an optical-electrical composite cable that has an even smaller diameter.

### REFERENCE SIGNS LIST

1A to 1F . . . optical-electrical composite cable, 10 . . . ribbon optical fiber, 12 . . . optical fiber core wire, 20 . . . tube, 30 . . . tension member, 40 . . . electromagnetic shield layer, 50 . . . sheath, 60 . . . electric wire, 61 . . . power line, 62 . . . coaxial wire, 71, 72 . . . filler, 80 . . . optical fiber, 81 . . . core, 82 . . . cladding, 86 . . . coating, 90 . . . tension member, C1, C2 . . . center axis line.

1. An optical-electrical composite cable comprising:
one or more optical fibers;
a tube accommodating the one or more optical fibers;
a sheath covering the tube; and
a plurality of electric wires arranged between an outer surface of the tube and an inner surface of the sheath,
wherein a center axis line of the tube and a center axis line of the sheath are apart from each other,
the center axis line of the sheath is located inside the tube, and
the plurality of electric wires are located eccentrically on an opposite side to the center axis line of the tube with respect to the center axis line of the sheath.

2. The optical-electrical composite cable according to claim 1, wherein the following formula is satisfied:
D1+2d1−D2≧\sqrt{(D1+D2)²−D2²} [Formula 1]
wherein D1 is an outer diameter of the tube, d1 is an inner diameter of the tube, and D2 is an outer diameter of a thickest electric wire of the plurality of electric wires.

3. The optical-electrical composite cable according to claim 1, further comprising one or more fillers arranged between the outer surface of the tube and the inner surface of the sheath.

4. The optical-electrical composite cable according to claim 3, wherein the following formula is satisfied:
D+2d1−D2≧\sqrt{(D1+D2)²−D2²}[Formula 2]
wherein D1 is an outer diameter of the tube, d1 is an inner diameter of the tube, and D2 is an outer diameter of a thickest electric wire or filler of the plurality of electric wires and the one or more fillers.

5. The optical-electrical composite cable according to claim 1, wherein the tube and all or at least some of the plurality of electric wires are intertwisted together, and at least the tube is intertwisted while being back-twisted.

6. The optical-electrical composite cable according to claim 1, wherein the tube and all or at least some of the plurality of electric wires are assembled while extending in parallel with each other along the center axis line of the sheath.

7. The optical-electrical composite cable according to claim 1, further comprising a tension member that is arranged inside the tube.
